(19) United States
(12) Patent Application Publication
(10) Pub. No.: US 2008/0279535 A1
(43) Pub. Date: Nov. 13, 2008

(54) Subtitle data customization and exposure

(75) Inventors: Shaheedur Reza Haque, Redmond, WA (US); Simon Steele, Redmond, WA (US); Maurice Cuijpers, Redmond, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 11/801,565

(22) Filed: May 10, 2007

(51) Int. Cl. H04N 5/91

(52) U.S. Cl. 386/95

(57) ABSTRACT

Techniques to customize and expose subtitle data are described. In an implementation, a client includes a network connection device, a processor and memory. The memory is configured to maintain one or more user preferences and one or more modules that are executable on the processor to receive subtitle data via the network connection device and configure the subtitle data to be output accordingly to the one or more user preferences.

### BACKGROUND

Subtitle data is typically configured as a textual representation of spoken audio and sounds in content, such as a television program. For example, the subtitle data may provide closed-captioning data that is used to provide a textual description of audio in a television program, such as spoken words as well as brief descriptions of other sounds that are also typically heard in the corresponding television program, e.g., a notification of the sound of a breaking glass. In another example, subtitle data may also be used with foreign languages, such as to provide a translation from a language spoken in a movie into a textual description using another language. Traditional techniques that were used to provide subtitle data, however, were static and inflexible and therefore needlessly consumed valuable resources of a provider of the subtitles as well as a network operator that distributed content with the subtitles.

Traditional subtitles, for instance, were generated after content was created, such as after making of a television program, filming of a movie, and so on. The subtitles were then incorporated as a part of the content (e.g., through multiplexing) for display in a particular manner. For example, the subtitles may be incorporated as bitmaps into the content for display concurrently with the content. Therefore, changes could not be made to the subtitles when so configured, such as to display in a different language. Consequently, incorporation of a different subtitle (e.g., in a different language) into the content typically involved repeating each of the steps that were already undertaken to generate the original subtitle, which was therefore inefficient to generate, store and communicate to clients.

### SUMMARY

Techniques to customize and expose subtitle data are described. In an implementation, a client includes a network connection device, a processor and memory. The memory is configured to maintain one or more user preferences and one or more modules that are executable on the processor to receive subtitle data via the network connection device and configure the subtitle data to be output accordingly to the one or more user preferences.

In another implementation, a head end includes a processor and memory configured to maintain a module that is executable on the processor to expose subtitle data to be located over a network connection using an identifier taken from metadata that is included in content that corresponds to the subtitle data.

In a further implementation, a head end includes a processor and memory configured to maintain a module that is executable on the processor to provide an option to a client that is to consume content regarding whether to stream the content without subtitle data.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an exemplary implementation that is operable to customize and expose subtitles.

FIG. 2 is an illustration of a system showing a head end and a client of FIG. 1 in greater detail.

FIG. 3 is an illustration of an exemplary user interface showing content and subtitle data of FIG. 2 that is displayed accordingly to a scrolling user preference.

FIG. 4 is a flow diagram depicting a procedure in an exemplary implementation in which subtitle data is generated and exposed for retrieval over a network connection.

FIG. 5 is a flow diagram depicting a procedure in an exemplary implementation in which subtitle data exposed via the procedure of FIG. 4 is retrieved and customized for output using one or more user preferences.

### DETAILED DESCRIPTION

### Overview

Subtitle data may be used for a variety of purposes, such as to provide a textual representation of spoken audio and sounds in content (e.g., closed-captioning data), a translation of a foreign language, and so on. Traditional techniques that were used to provide subtitle data, however, oftentimes incorporated the subtitle data within the content such that the subtitle data could not be separated from the content. Therefore, the subtitle data was traditionally communicated with the content regardless of whether the subtitle data was going to be utilized, which would needlessly consume valuable resources on the part of the network operator and client. Further, the subtitle data was oftentimes provided in a form such that the subtitle data could not be modified, such as by providing the subtitle data as a bitmap for display within the content.

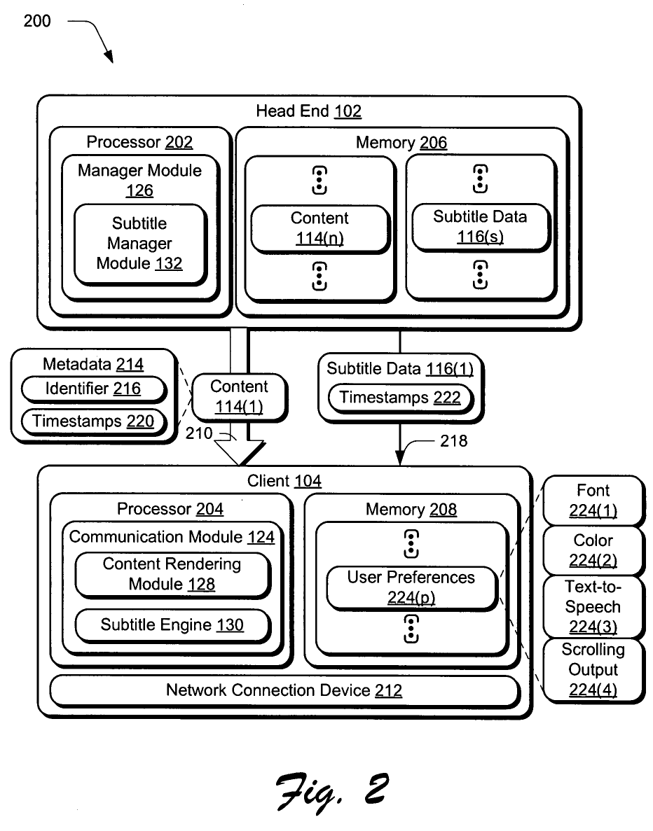

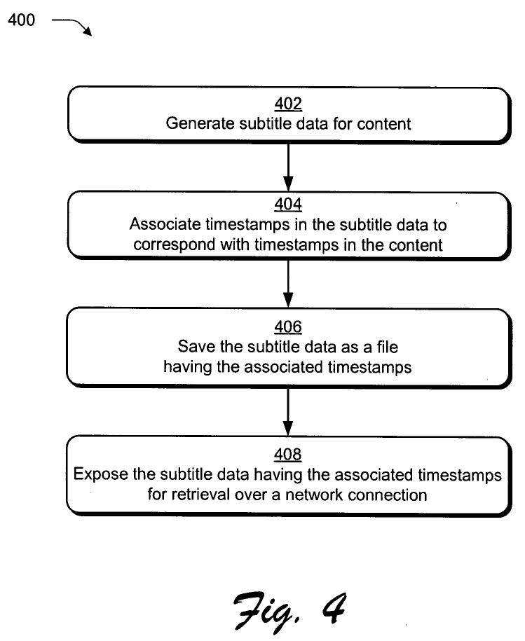

Techniques are described that provide subtitle customization and/or exposure. In an implementation, subtitle data and content are provided separately, e.g., in separate data streams. Thus, in this implementation the subtitle data may be provided as desired, thereby conserving resources of a head end that provides the content, a network that is used to communicate the content and/or a client that is to store and/or output the content. Further discussion of subtitle data exposure may be found in relation to FIGS. 2 and 4.

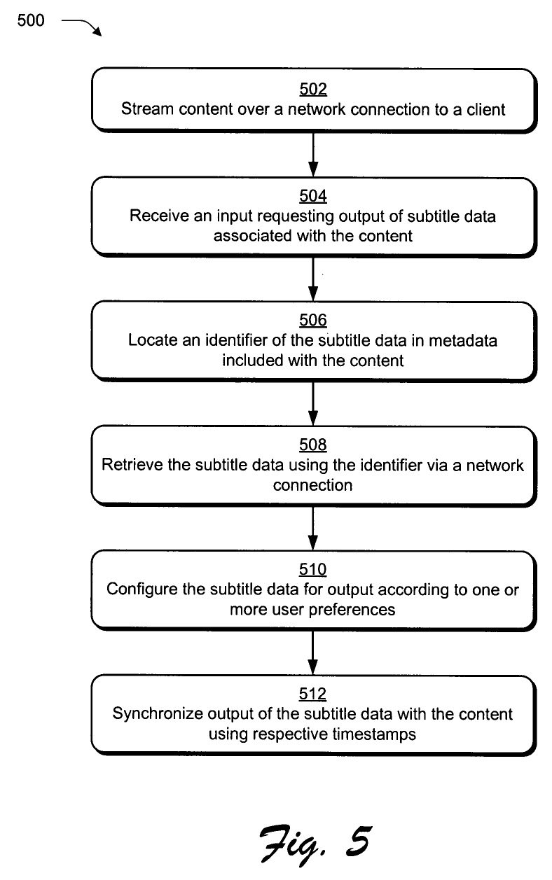

In another implementation, the subtitle data that is exposed is suitable for customization at a client that receives the subtitle data. The subtitle data, for instance, may be provided as ASCII characters in a text file. Therefore, the subtitle data may be displayed based on user preferences, such as particular fonts, colors, displayed using particular techniques (e.g., static versus scrolling), use text-to-speech conversion, and so on. Further discussion of subtitle data customization may be found in relation to FIGS. 2 and 5.

In the following discussion, an exemplary environment is first described that is operable to perform techniques to customize and expose subtitle data. Exemplary procedures are then described that may be employed in the exemplary environment, as well as in other environments. Although these techniques are described as employed within a television environment in the following discussion, it should be readily apparent that these techniques may be incorporated within a variety of environments without departing from the spirit and scope thereof.

### EXEMPLARY ENVIRONMENT

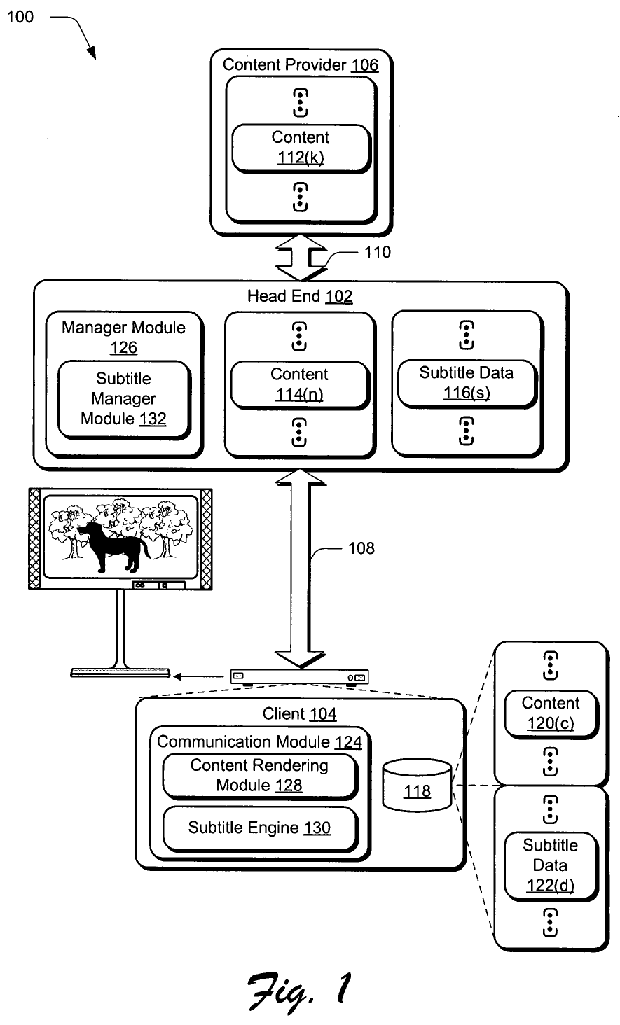

FIG. 1 is an illustration of an environment 100 in an exemplary implementation that is operable to customize and expose subtitle data. The illustrated environment 100 includes a head end 102 of a network operator, a client 104 and a content provider 106 that are communicatively coupled, one to another, via network connections 108, 110. In the following discussion, the head end 102, the client 104 and the content provider 106 may be representative of one or more entities, and therefore reference may be made to a single entity (e.g., the client 104) or multiple entities (e.g., the clients 104, the plurality of clients 104, and so on). Additionally, although a plurality of network connections 108, 110 are shown separately, the network connections 108, 110 may be representative of network connections achieved using a single network or multiple networks. For example, network connection 108 may be representative of a broadcast network with back channel communication, an Internet Protocol (IP) network, and so on.

The client 104 may be configured in a variety of ways. For example, the client 104 may be configured as a computer that is capable of communicating over the network connection 108, such as a desktop computer, a mobile station, an entertainment appliance, a set-top box communicatively coupled to a display device as illustrated, a wireless phone, and so forth. For purposes of the following discussion, the client 104 may also relate to a person and/or entity that operate the client. In other words, client 104 may describe a logical client that includes a user, software and/or a machine.

The content provider 106 includes one or more items of content 112(k), where “k” can be any integer from 1 to “K”. The content 112(k) may include a variety of data, such as television programming, video-on-demand (VOD) files, one or more results of remote application processing, and so on. The content 112(k) is communicated over the network connection 110 to the head end 102.

Content 112(k) communicated via the network connection 110 is received by the head end 102 and may be stored as one or more items of content 114(n), where “n” can be any integer from “1” to “N”. The content 114(n) may be the same as or different from the content 112(k) received from the content provider 106. The content 114(n), for instance, may include additional data for broadcast to the client 104. For example, the content 114(n) may include electronic program guide (EPG) data from an EPG database for broadcast to the client 104 utilizing a carousel file system. The carousel file system repeatedly broadcasts the EPG data over an out-of-band (OOB) channel to the client 104 over the network connection 108. Distribution from the head end 102 to the client 104 may be accommodated in a number of ways, including cable, radio frequency (RF), microwave, digital subscriber line (DSL), and satellite.

The content 114(n) may also be associated with subtitle data 116(s), where “s” can be any integer from one to “S”. As previously described, subtitle data 116(s) may be configured in a variety of ways, such as a textual representation of spoken audio and other sounds in content, such as a television program. For example, the subtitle data 116(s) may provide closed-captioning data that is used to provide a textual description of audio in a television program, such as spoken words as well as brief descriptions of other sounds that are also typically heard in the corresponding television program, e.g., a notification of the sound of a breaking glass. Subtitle data 116(s) may also be used with foreign languages, such as to provide a translation from one language to another. The subtitle data 116(s) may be stored in a variety of ways, such as in a form of text that is not suitable for rendering directly by the client 104 until it is further processed. The head end 102 may provide the subtitle data 116(s) to the client 104 in a variety of ways, such as through streaming “with” the content 114(n) over the network connection 108, before the content 114(n) is streamed (e.g., as a file), and so on using any one of the previously described communication techniques.

The client 104, as previously stated, may be configured in a variety of ways to receive the content 114(n) over the network connection 108. The client 104 typically includes hardware and software to transport and decrypt content 114(n) received from the head end 102 for rendering by the illustrated display device. Although a display device is shown, a variety of other output devices are also contemplated, such as speakers.

The client 104 may also include digital video recorder (DVR) functionality. For instance, the client 104 may include a storage device 118 to record content 114(n) as content 120(c) (where “c” can be any integer from one to “C”) received via the network connection 108 for output to and rendering by the display device. The storage device 118 may be configured in a variety of ways, such as a hard disk drive, a removable computer-readable medium (e.g., a writable digital video disc), and so on. Thus, content 120(c) that is stored in the storage device 118 of the client 104 may be copies of the content 114(n) that was streamed from the head end 102. Additionally, content 120(c) may be obtained from a variety of other sources, such as from a computer-readable medium that is accessed by the client 104, and so on. Further, the content 120(c) may also include subtitle data 122(d), which may be the same as or different from subtitle data 116(s).

The client 104 includes a communication module 124 that is executable on the client 104 to control content playback on the client 104, such as through the use of one or more “command modes”, i.e., “trick modes”. The command modes may provide non-linear playback of the content 120(c) (i.e., time shift the playback of the content 120(c)) such as pause, rewind, fast forward, slow motion playback, and the like.

The head end 102 is illustrated as including a manager module 126. The manager module 126 is representative of functionality to configure content 114(n) for output (e.g., streaming) over the network connection 108 to the client 104. The manager module 126, for instance, may configure content 112(k) received from the content provider 106 to be suitable for transmission over the network connection 108, such as to “packetize” the content for distribution over the Internet, configuration for a particular broadcast channel, map the content 112(k) to particular channels, and so on.

Thus, in the environment 100 of FIG. 1, the content provider 106 may broadcast the content 112(k) over a network connection 110 to a multiplicity of network operators, an example of which is illustrated as head end 102. The head end 102 may then stream the content 114(n) over a network connection to a multitude of clients, an example of which is illustrated as client 104. The client 104 may then store the content 114(n) in the storage device 118 as content 120(c) and/or render the content 114(n) immediately for output as it is received, such as when the client 104 is configured to include digital video recorder (DVR) functionality.

The content 114(n) may also be representative of time-shifted content, such as video-on-demand (VOD) content that is streamed to the client 104 when requested, such as movies, sporting events, and so on. For example, the head end 102 may execute the manager module 126 to provide a VOD system such that the content provider 106 supplies content 112(k) in the form of complete content files to the head end 102. The head end 102 may then store the content 112(k) as content 114(n). The client 104 may then request playback of desired content 114(n) by contacting the head end 102 (e.g., a VOD server) and requesting a feed of the desired content.

In another example, the content 114(n) may further be representative of content (e.g., content 112(k)) that was recorded by the head end 102 in response to a request from the client 104, in what may be referred to as a network DVR example. Like VOD, the recorded content 114(n) may then be streamed to the client 104 when requested. Interaction with the content 114(n) by the client 104 may be similar to interaction that may be performed when the content 120(c) is stored locally in the storage device 118.

Traditional techniques that were utilized to provide subtitle data had a close affinity with their roots in analog television systems, such as use of inefficient encoding techniques inherited from a need to be robust in the face of analog radio frequency transmission techniques and be repeated for each frame. These traditional techniques also offered inflexible presentation, were limited to legacy formats and were present in the content when streamed regardless of whether the subtitle data was going to be utilized by a client. Further, these traditional techniques were implicitly synchronized with content using standard MPEG timing facilities. To do so, however, involved the use of complex multiplexing equipment to insert the original subtitle data into the stream of content in a properly synchronized fashion. While these techniques were acceptable for traditional broadcast systems, it became onerous for VOD systems. For example, multi-language subtitle capabilities could not be provided in some traditional systems due to relatively low bitrates available in the systems.

The environment 100 of FIG. 1, however, is configured to employ techniques to expose and customize subtitle data. For example, the communication module 124 is illustrated as including a content rendering module 128 and a subtitle engine 130. The content rendering module 128 is representative of functionality to render content 114(n), 120(c) for output. The subtitle engine 130 is representative of functionality to manage subtitle data 116(s), 122(d). The subtitle engine 130 is illustrated as separate from the content rendering module 128 to indicate that the subtitle data 116(s), 122(d) may be rendered using techniques that are not applied to the content 116(s), 120(c), such as to display the subtitle data 116(s), 122(d) using a particular font, in a particular color, decode using a particular encryption technique, and so on, further discussion of which may be found in relation to FIG. 2. Thus, the subtitle data 116(s), 122(d) may be customized at the head end 102 and/or the client 104, thereby providing increased flexibility on how subtitle data 116(s), 122(d) is communicated and/or rendered by the subtitle engine 130.

The environment 100 may also employ techniques to expose the subtitle data 116(s) separately from the content 114(n). For example, the head end 102 is illustrated as including a subtitle manager module 132 that is representative of functionality to provide the subtitle data 116(s) over the network connection 108 to the client 104. The subtitle engine 130, for instance, may obtain the subtitle data 116(s) from a third-party service that generated the subtitle data 116(s) to correspond with the content 114(n). In another instance, the subtitle engine 130 may also be representative of functionality to generate the subtitle data 116(s) itself, such as when included as a part of the subtitle manager module 132 of the head end 102. The subtitle data 116(s) is illustrated separately from the content 114(n) in FIG. 2 to depict that the subtitle data 116(s) may be provided separately from the content 114(n) when desired. In this way, the resources of the environment 100 (e.g., the head end 102, the network(s) that provide the network connection 108 and/or the client 104) may be conserved. Further discussion of subtitle data 116(s) exposure may be found in relation to the following figure.

It should be noted that one or more of the entities shown in FIG. 1 may be further divided (e.g., the head end 102 may be implemented by a plurality of servers in a distributed computing system), combined (e.g., the head end 102 may incorporate functionality to generate the subtitle data 116(s)), and so on and thus the environment 100 of FIG. 1 is illustrative of one of a plurality of different environments that may employ the described techniques.

FIG. 2 depicts a system 200 in an exemplary implementation showing the head end 102 and the client 104 in greater detail. The head end 102 and the client 104 are both illustrated as devices having respective processors 202, 204 and memory 206, 208. Processors are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions. Additionally, although a single memory 206, 208 is shown, respectively, for the head end 102 and the client 104, a wide variety of types and combinations of memory may be employed, such as random access memory (RAM), hard disk memory, removable medium memory, and other types of computer-readable media.

Content 114(1) in the system 200 of FIG. 2 is illustrated as being streamed 210 by the head end 102 to a network connection device 212 of the client 104, such as through execution of the manager module 126. The network connection device 212 may be configured in a variety of different ways, such as to operate as a tuner to receive broadcast content, communicate via an internet protocol (IP) network, and so on. In an implementation, the network connection device 212 is configured to receive content 114(1) over a network connection that is different than that used to receive subtitle data 116(1), such as to receive content 114(1) via a broadcast network and subtitle data 116(1) via an IP network. A variety of other examples are also contemplated.

This content 114(1) may then be rendered by the communication module 124 for output, such as through use of the content rendering module 128 as previously described. For example, rendering of the content 114(1) may include processing of the content 114(1) to be suitable for output, such as “drawing” of images from a file into a visual form on the display device of FIG. 1, converting an audio file into audio suitable for output via speakers that are also illustrated as included on the display device of FIG. 1, and so on.

The client 104 may also utilize the subtitle engine 130 to obtain subtitle data 116(1) that corresponds to the content 114(1). The content 114(1), for instance, may include an identifier 216 of the content 114(1), such as a title, a globally unique identifier (GUID), and so on. The identifier 216 may then be used by the subtitle engine 130 to request subtitle data 116(1) that corresponds to the content 114(1), such as by providing the identifier 216 to the subtitle manager module 132 which then communicates (e.g., streams 218) the subtitle data 116(1) to the client 104. Thus, in this way the subtitle data 116(1) may be provided as desired, thereby conserving resources of the environment 100. A variety of other examples are also contemplated, further discussion of which may be found in relation to FIGS. 4 and 5.

The subtitle engine 130 may also synchronize output of the subtitle data 116(1) with output of the content 114(1). For example, as previously described the output of the content 114(1) in some instances may be “time shifted”, such as through use of one or more control functions in a VOD system. Therefore, the subtitle engine 130 may be used to locate timestamps 220 in the content 114(1) and output subtitle data 116(1) having corresponding timestamps 222. In this way, the subtitle engine 130 provides functionality which may track the “current position” of time-shifted content to output subtitle data 116(1) in a synchronized manner with the content 114(1) regardless of whether control functions are used to time-shift an output of the content 114(1), e.g., to fast forward, rewind, pause, and so on.

The subtitle engine 130 may also be used to apply one or more user preferences 224(p) (where “p” can be any integer from one to “P”) to customize the output of the subtitle data 116(1). For example, a particular font 224(1) and/or color 224(2) may be applied to the subtitle data 116(1) for output. The subtitle data 116(1) may then be rendered for output by the subtitle engine 130 using the selected font 224(1) and/or color 224(2).

In another example, the subtitle engine 130 may provide an option for text-to-speech 224(3) conversion of the subtitle data 116(1). For instance, the subtitle data 116(1) may be configured in a text format, such as through use of ASCII characters. The subtitle data 116(1) in this textual format may then be converted to speech for output, such as by using an appropriate text-to-speech engine based on a selection made by a user of the client 104. Thus, users that prefer not to and/or are incapable of reading the textual subtitle data 116(1) may be provided with an audio output, such as for user's having visual disabilities. In another instance, the text-to-speech 224(3) conversion may be used to provide translation from one language to another, such as from English text to Spanish speech through use of a corresponding translation engine. A variety of other instances are also contemplated, such as to convert text from one language into text in another language.

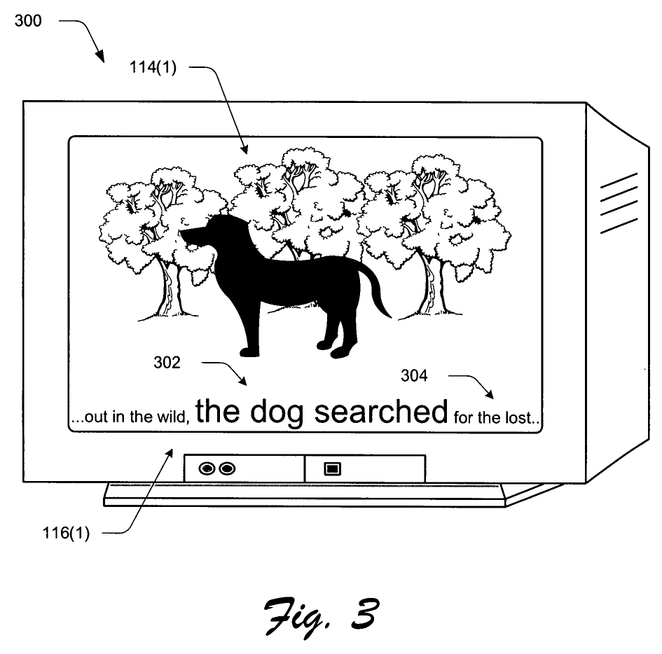

In a further example, the user preferences may specify whether to employ a scrolling output 224(4). Referring to FIG. 3, for instance, an exemplary user interface 300 is illustrated which includes a concurrent display of the content 114(1) and the subtitle data 116(1) of FIG. 1. In this example, the scrolling output 224(4) is specified such that the subtitle 116(1) is scrolled across the user interface 300 from right to left at a speed that is synchronized with the content 114(1) being displayed. This scrolling may be performed in a variety of ways and use a variety of display techniques, such as to incorporate a portion 302 of the subtitle data 116(1) that is magnified, e.g., displayed using text that is larger than text used to display another portion 304 of the subtitle data 116(1). This portion 302 that is magnified may be synchronized with the output of the content 114(1), while the other portions (e.g., portion 304) provide information on what is about to occur and/or has just occurred to give context. It should be apparent that a wide variety of other examples of subtitle data 116(1) output are also contemplated without departing from the spirit and scope thereof, such as through use of a traditional static output.

In this way, the techniques described herein in relation to FIGS. 1-3 may separate the subtitle data 116(1) from the restrictions that were traditionally carried over from “legacy” systems that relied on MPEG alone to provide the content 114(1) and the subtitle data 116(1) in combination, which may be used to provide addition functionality in the provision of the subtitle data 116(1). For example, the subtitle data 116(1) may be encoded using techniques that are different from the techniques used to encode the content 114(1) and therefore may take advantage of different compression and display techniques. In another example, the subtitle data 116(s) exposed by the head end 102 may be provided as an original subtitle data file (e.g., in European Broadcasting Union (EBU) 3264 teletext file format, typically with an extension of “.stl”) that may be exposed for direct consumption by the client 104 without using the complex multiplexing mechanisms traditionally employed. A variety of other examples are also contemplated, further discussion of which may be found in relation to the following procedures.

Generally, any of the functions described herein can be implemented using software, firmware, hardware (e.g., fixed-logic circuitry), manual processing, or a combination of these implementations. The terms “module”, “functionality”, “engine” and “logic” as used herein generally represent software, firmware, hardware, or a combination thereof. In the case of a software implementation, for instance, the module, functionality, or logic represents program code that performs specified tasks when executed on a processor (e.g., CPU or CPUs). The program code can be stored in one or more computer-readable memory devices. The features of the techniques to customize and expose subtitle data are platform-independent, meaning that the techniques may be implemented on a variety of commercial computing platforms having a variety of processors.

### EXEMPLARY PROCEDURES

The following discussion describes subtitle data techniques that may be implemented utilizing the previously described environment, systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference will be made to the environment 100 of FIG. 1 the system 200 of FIG. 2 and/or the user interface 300 of FIG. 3.

FIG. 4 depicts a procedure 400 in an exemplary implementation in which subtitle data is generated and exposed for retrieval over a network connection. Subtitle data is generated for content (block 402). For example, a third-party subtitle service, the head end 102 of FIGS. 1 and 2, and so on may receive content 114(n) and generate subtitle data 116(s) that corresponds to the content. The subtitle data 116(s) may be configured in a variety of ways, such as a textual file, according to European Broadcasting Union (EBU) 3264 teletext file format, in an extensible markup language (XML) file, and so on.

Timestamps are then associated in the subtitle data to correspond with timestamps in the content (block 404). The timestamps 222 in the subtitle data 116(1), for instance, may be configured to match timestamps 220 included in the content 114(1), such as to match counters included in the content 114(1).

The subtitle data is then saved as a file having the associated timestamps (block 406) and exposed for retrieval over a network connection (block 408). The subtitle data 116(s), for instance, may be made available at the head end 102 or third-party service at a particular network address. This subtitle data 116(s) may also be combined with “box art” and supplementary materials (e.g., director commentary). Further discussion of retrieval of this exposed subtitle data 116(s) may be found in relation to the following figure.

FIG. 5 depicts a procedure 500 in an exemplary implementation in which subtitle data exposed via the procedure 400 of FIG. 4 is retrieved and customized for output using one or more user preferences. Content is streamed over a network connection to a client (block 502). Content 114(1), for instance, may be streamed by the head end 102 and configured as television programming, video-on-demand, movies recorded in a NDVR, and so on.

An input is received requesting output of subtitle data associated with the content (block 504). A user, for instance, may utilize a remote control to select between a variety of options, each corresponding to different languages of subtitle data that correspond to the content 114(1).

An identifier is located in metadata that is included with the content of the subtitle data (block 506) that was selected. In an implementation, the metadata 214 includes an identifier for each of the subtitle options that are available. In another implementation, however, the identifier 216 may identify the content 114(1).

The subtitle data is retrieved using the identifier via a network connection (block 508). Continuing with the previous examples, the identifier may correspond to subtitle data 116(1) in a particular language and therefore be used by the subtitle manager module 132 to locate this particular subtitle data 116(1). In another example, the identifier 216 may identify the content 114(1) and therefore used by the subtitle manager module 132 to locate that subtitle data 116(s) from a plurality of different subtitle data. A variety of other examples are also contemplated. The subtitle data 116(1) may then be communicated to the client 104, such as via a file, streamed 218 over a network connection to be synchronized with the content 114(1), and so on. Therefore, in this example, subtitle data that is available for output but not selected by a user is not communicated while subtitle data that is selected is communication, thereby conserving network and client 104 resources from having to communicate and/or store subtitle data that is not going to be utilized. In this way, the head end 102 provides an option of whether to stream subtitle data with content or to stream the content itself without the subtitle data.

The subtitle data is configured for output accordingly to one or more user preferences (block 510). Preferences may be set at the client 104 that dictate how the subtitle data is to be output. For example, the subtitle data may be configured as a textual file (e.g., include ASCII characters) that may be rendering according of a variety of preferences, such as font 224(1), color 224(2), use text-to-speech 224(3) conversion, use a scrolling output 224(4), and so on.

The output of the subtitle data is synchronized with the content using respective timestamps (block 512). As previously described, command modes may also be used to output the content 114(1), such as to fast forward, rewind, pause, slow-motion playback, and so on. Therefore, the subtitle engine 130 may use timestamps 222 in the subtitle data 116(1) to synchronize output with the timestamps 220 in the metadata 214 of the content 114(1). Therefore, the command modes may be employed while still preserving synchronization between the content 114(1) and the subtitle data 116(1). For example, a search may be performed for a particular string in the subtitle data to navigate to a corresponding part of the content using timestamps that correspond to the particular strings and the corresponding part of the content, respectively. For instance, a search may be performed for a particular string of characters. A timestamp that corresponds to the particular string of characters in the subtitle data may then be used to find a corresponding timestamp in the content to synchronize the output, one to another. In an implementation, at least a portion of the subtitle data 116(1) is displayed in conjunction with the content 114(1) when the content is fast-forwarded or rewound during output. For example, the subtitle data 116(1) that corresponds to every “X” frame in the content 114(1) may be output. A variety of other examples are also contemplated.

### CONCLUSION

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

What is claimed is:

1. A client comprising:
a network connection device;
a processor; and
memory configured to maintain one or more user preferences and one or more modules that are executable on the processor to receive subtitle data via the network connection device and configure the subtitle data to be output according to the one or more user preferences.

2. A client as described in claim 1, wherein the one or more modules are configured to synchronize output of the subtitle data with content by comparing timestamps in the content with timestamps included with the subtitle data.

3. A client as described in claim 1, wherein the user preferences specify whether to employ text-to-speech conversion such that text included in the subtitle data is converted to speech.

4. A client as described in claim 1, wherein the user preferences specify how text included in the subtitle data is to appear when rendered.

5. A client as described in claim 1, wherein the user preferences specify fonts or colors to be used to display text included in the subtitle data when displayed in conjunction with content that corresponds to the subtitle data.

6. A client as described in claim 1, wherein the user preferences specify whether the subtitle data is to be scrolled.

7. A client as described in claim 1, wherein the one or more modules are further configured to retrieve the subtitle data over a network connection using an identifier taken from metadata included with content that corresponds to the subtitle data.

8. A client as described in claim 7, wherein:
the retrieval is performed in response to a selection made by a user of one of a plurality of subtitle data available for output with the content; and
at least one said subtitle data that is available for output with the content that is not selected is not retrieved.

9. A client as described in claim 1, wherein:
the one or more modules are configured to render the subtitle data for output on a display device; and
the subtitle data, when received at the network connection device, is not suitable to be output at the display device until rendered by the one or more modules.

10. A client as described in claim 1, wherein:
the network connection device is configured to receive content that corresponds to the subtitle data via a network connection that is different than a network connection used to receive the subtitle data; and
the one or more modules are configured to display at least a portion of the subtitle data in conjunction with the content when the content is fast-forwarded or rewound during output.

11. A head end comprising:
a processor; and
memory configured to maintain a module that is executable on the processor to expose subtitle data to be located over a network connection using an identifier taken from metadata that is included in content that corresponds to the subtitle data.

12. A head end as described in claim 11, wherein the subtitle data is exposed for communication as a single file.

13. A head end as described in claim 11, wherein the subtitle data is configured separately from the content such that the subtitle data is customizable by a client that receives the subtitle data and the content without customizing output of the content.

14. A head end as described in claim 11, wherein the exposed subtitle data is stored as text in the memory.

15. A head end as described in claim 14, wherein the text includes one or more characters encoded in a common form using ASCII or UTF-8.

16. A head end as described in claim 11, wherein the module is further executable to translate text in the subtitle data from one language to another.

17. A head end as described in claim 11, wherein the content is video-on-demand content.

18. A head end comprising:
a processor; and
memory configured to maintain a module that is executable on the processor to provide an option to a client that is to consume content regarding whether to stream the content without subtitle data.

19. A head end as described in claim 18, wherein the subtitle data is customizable by the client.

20. A head end as described in claim 18, wherein the subtitle data and the content each include timestamps that are configured to synchronize output of the content with the subtitle data such that a search may be performed for particular strings in the subtitle data to navigate to a corresponding part of the content using timestamps that correspond to the particular strings and the corresponding part of the content, respectively.
